(19) United States
(12) Patent Application Publication
(10) Pub. No.: US 2007/0120047 A1
(43) Pub. Date: May 31, 2007

(54) Ring-configured photodiode array and optical encoders using the same

(76) Inventors: Weng Fei Wong, Penang (MY); Chee Foo Lum, Penang (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/287,176

(22) Filed: Nov. 25, 2005

(51) Int. Cl. G01D 5/34

(52) U.S. Cl. 250/231.13

(57) ABSTRACT

A photodiode array and an encoder utilizing the same is disclosed. The encoder includes the photodiode array, a code wheel, a light source, and an optical system. The photodiode array includes a plurality of photodiodes arranged in a ring, each photodiode includes an annular sector of the ring, each photodiode generates a signal determined by the optical radiation incident on the photodiode, the photodiode array is characterized by an array center. The code wheel includes an annular array of alternating code stripes disposed about a code wheel axis, the code wheel moving relative to the photodiode array about the code wheel axis. The light source illuminates the code wheel and the optical system forms an image of the code wheel having alternating light and dark bands on the photodiode array.

### BACKGROUND OF THE INVENTION

Encoders provide a measurement of the position of a component in a system relative to some predetermined reference point. Encoders are typically used to provide a closed-loop feedback system to a motor or other actuator. For example, a shaft encoder outputs a digital signal that indicates the position of the rotating shaft relative to some known reference position that is not moving. Optical encoders utilize a light source and a photo detector to measure changes in the position of an encoding pattern that is carried on a code disk or strip.

In a transmissive encoder, the encoding disk/strip includes a series of alternating opaque and transparent bands. The light source is located on one side of the encoding pattern, and the photodetector is located on the other side of the encoding pattern. The light source and photodetector are fixed relative to one another, and the encoding pattern moves between the photodetector and the detector such that the light reaching the photodetector is interrupted by the opaque regions of the encoding pattern. The position of the encoding pattern is determined by measuring the transitions between the light and dark regions observed by the photodiode.

In a reflective encoder, the light source and photodetector are located on the same side of the encoding pattern, and the encoding pattern consists of alternating reflective and absorbing stripes. The light source is positioned such that light from the light source illuminates the encoding pattern and the light leaving the encoding pattern is then used to generate an image that is superimposed on one or more photodiodes that are fixed relative to the motion of the encoding pattern.

In a shaft encoder, the encoding pattern is typically part of a disk that is connected to the shaft and rotates past the photodetectors as the shaft moves. The encoding pattern consists of an annulus having a center that is coincident with that of the shaft. The photodetectors are mounted on a surface that is fixed such that the encoding pattern moves past the photodetectors. The photodetectors must be aligned with respect to the encoding pattern during the assembly of the part that utilizes the encoder.

There is a trend toward smaller parts having encoders with increased resolution. This trend requires increased accuracy in the alignment of the encoding pattern with the photodetector array. Providing the needed alignment substantially increases the cost of assembly of small high-resolution encoders.

### SUMMARY OF THE INVENTION

The present invention includes a photodiode array and an encoder utilizing the same. The encoder includes the photodiode array, a code wheel, a light source, and an optical system. The photodiode array includes a plurality of photodiodes arranged in a ring, each photodiode includes an annular sector of the ring, each photodiode generates a signal determined by the optical radiation incident on the photodiode, the photodiode array is characterized by an array center. The code wheel includes an annular array of alternating bands disposed about a code wheel axis, the code wheel moving relative to the photodiode array about the code wheel axis. The light source illuminates the code wheel and the optical system forms an image of the code wheel having alternating light and dark bands on the photodiode array. In one aspect of the invention, the photodiodes are arranged in a plurality of groups around the ring. Each group includes a plurality of photodiodes in which each photodiode is assigned to a class. For each photodiode of a particular class in one of the groups, there is a corresponding photodiode of that class at a position diametrically opposed to that photodiode in the ring. In another aspect of the invention, the encoder includes a plurality of sum circuits, each sum circuit generating a signal related to a sum of the signals from all of the photodiodes in one of the classes. The encoder can be constructed in either a transmissive or reflective mode. In addition, encoders that utilize a plurality of channels can be constructed.

### BRIEF DESCRIPTION OF THE DRAWINGS

FIG. 1 illustrates a transmissive encoder.

FIG. 2 illustrates one type of reflective encoder.

FIG. 3 illustrates another form of imaging encoder.

FIG. 4 is a top view of the encoding disk.

FIG. 5 is a cross-sectional view through line 5-5 shown in FIG. 4.

FIG. 6 illustrates a prior art two-channel encoder 200.

FIG. 7 is a graph of the amplitude of the output of each photodetector as a function of position of the code disk/wheel image.

FIG. 8 illustrates two logic channel signals that are 90 degrees out of phase.

FIGS. 9 and 10 illustrate a photodiode array according to one embodiment of the present invention and the corresponding code wheel, respectively.

FIG. 11 is a cross-sectional view of a transmissive encoder for measuring the position of a shaft.

FIG. 12 illustrates a photodiode array in which only a portion of the ring is actually populated with photodiodes.

FIG. 13 is a cross-sectional view of a reflective imaging encoder according to one embodiment of the present invention.

FIGS. 14 and 15 illustrate another embodiment of a reflective encoder according to the present invention.

FIGS. 16 and 17 illustrate a photodiode array 180 and a corresponding code wheel 182 for a single channel encoder.

### DETAILED DESCRIPTION OF THE PREFERRED EMBODIMENTS OF THE INVENTION

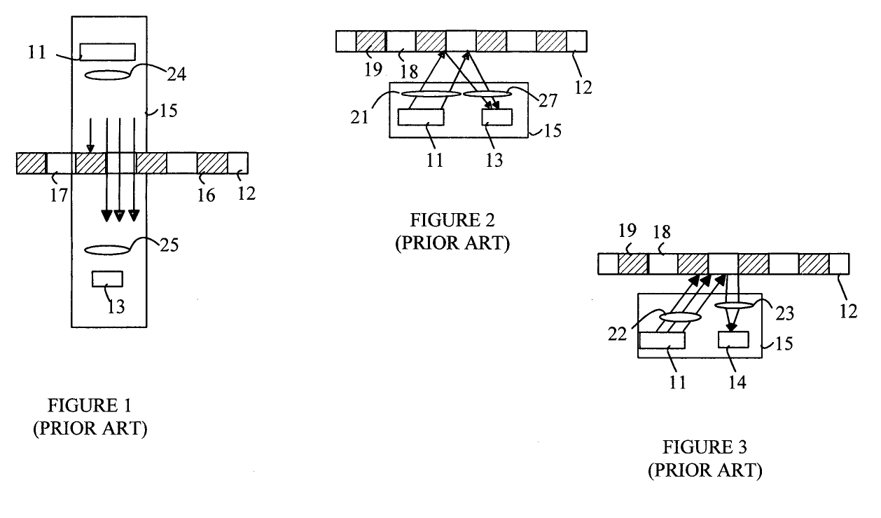

Refer now to FIGS. 1-3, which illustrate some typical encoder designs. The encoder can be divided into an emitter/detector module 15 and a code wheel or code strip. Module 15 includes an emitter 11 that illuminates a portion of the code strip 12. A detector 13 views the illuminated code strip. The emitter typically utilizes an LED as the light source. The detector is typically based on one or more photodiodes. FIG. 1 illustrates a transmissive encoder. In transmissive encoders, the light from the emitter is collimated into a parallel beam by a collimating optic such as lens 24. Code strip 12 includes opaque stripes 16 and transparent stripes 17. When code strip 12 moves between emitter 11 and detector 13, the light beam is interrupted by the opaque stripes on the code strip. The photodiodes in the detector receive flashes of light. The resultant signal is then used to generate a logic signal that transitions between logical one and logical zero.

The detector can include an imaging lens 25 that images the collimated light onto the photodiode. Lens 25 can be used to adjust the size of the light stripes to match the size of the photodiode or photodiodes in the detector. When used in this manner, the photodetector is placed at a point between the code strip and the focal point of lens 25. The distance between the photodetector and the lens determines the size of the code strip image on the photodetector.

In general, the collimator is constructed from two separate sub-modules that are provided to the manufacturer of the encoder. The first sub-module includes the light source consisting of emitter 11 and lens 24. The second sub-module consists of photodetector 13 and lens 25. Since the light is collimated, the only critical distances are those between emitter 11 and lens 24 and between lens 25 and photodetector 13. The sub-module manufacturer can control these distances to a high level of precision. Hence, the tolerances that need to be maintained by the encoder manufacturer are substantially reduced in transmissive designs.

FIG. 2 illustrates one type of reflective encoder. In reflective encoders, the code strip includes reflective stripes 18 and absorptive stripes 19. The emitter includes an optical system such as a lens 21 that images the emitter light source into the detector when the light strikes a reflective stripe on the code strip. The light from the emitter is reflected or absorbed by the stripes on the code strip. The output from the photodetector is again converted to a logic signal. In embodiments in which the photodetector includes a plurality of photodiodes that provide a signal that depends on matching an image of the strips to the photodiodes, a second lens 27 can be included to adjust the size of the code strip image to the size of the photodetectors in a manner analogous to that described above.

FIG. 3 illustrates another form of imaging encoder. An imaging encoder operates essentially the same as the reflective encoder described above, except that module 15 includes imaging optic 23 that forms an image of the illuminated code strip on the detector 14. In addition, the light source is processed by lens 22 such that the code strip is uniformly illuminated in the region imaged onto the detector.

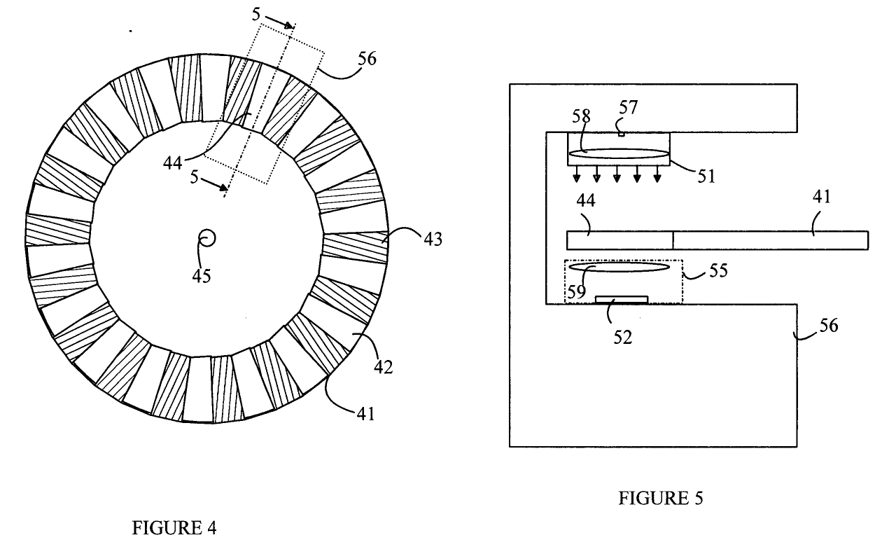

To simplify the following discussion, a multi-channel transmissive encoder will be used. Refer now to FIGS. 4 and 5, which illustrate a transmissive encoder. FIG. 4 is a top view of the encoding disk and FIG. 5 is a cross-sectional view through line 5-5 shown in FIG. 4. Code disk 41 includes an encoding pattern having a series of pie-shaped bands in an annular region around the outside edge of the code disk. The code disk 41 rotates about shaft 45 such that the encoding pattern remains fixed radially with respect to shaft 45. The encoding pattern consists of alternating opaque and transmissive bands. Exemplary opaque bands are shown at 43, and exemplary transparent bands are shown at 42.

Referring to FIG. 5, the encoder includes a light source 51 and a light receiver 55 that are mounted on a body 56 that is fixed relative to the moving code disk. Light source 51 typically includes an LED 57 and a collimating lens 58 positioned such that the light leaving light source 51 is collimated. The light illuminates a number of adjacent bands.

If the light is perfectly collimated, the light pattern under code strip 44 is a series of light and dark bands having the same size as the bands on the code disk. This pattern is imaged onto a detector array 52 in receiver 55 by a lens 59 such that the size of the band pattern seen by the detector array is matched to the size of the individual detectors in the array.

In multichannel encoders, the properly magnified band pattern is imaged on a photodetector array. An image of one portion of the band pattern is generated on the photosensitive area of a photodiode in an array of photodiodes. To simplify the following discussion, drawings depicting the image of the encoding pattern and the surface area of the photodetectors on which the image is formed will be utilized. In each drawing, the image of the encoding pattern will be shown next to the photodiode array to simplify the drawing. However, it is to be understood that, in practice, the image of the encoding pattern would be projected onto the surface of the photodiode array. In addition, to further simplify the drawings, the light source and any collimating or imaging optics are omitted from the drawings.

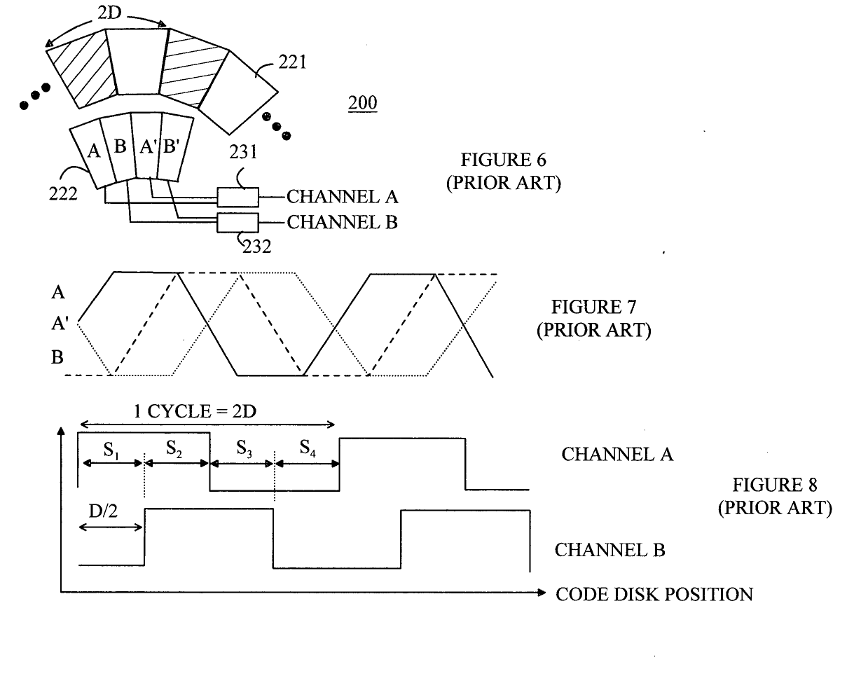

Refer now to FIG. 6, which illustrates a prior art two-channel encoder 200. Encoder 200 includes an encoding pattern that is imaged to form an image 221 that is viewed by a detector array 222. The image 221 of the encoding pattern consists of alternating “white” and “black” bands. For the purposes of this example, it will be assumed that when a “white” band is imaged on the detector, the detector outputs its maximum signal value, and when a “black” band is imaged on the detector, the detector outputs its minimum value. It will also be assumed that the detector outputs an intermediate value when only a portion of a “white” band is imaged onto the detector.

Detector array 222 is constructed from 4 photodetectors labeled A, A′, B, and B′. Each photodetector views a portion of image 221 that has an area that is one half the area of one band in the image. The A′ and B′ detectors are positioned such that the A′ and B′ detectors generate the complement of the signal generated by the A and B detectors, respectively. The outputs of the A, A′, and B photodetectors are shown in FIG. 7, which is a graph of the amplitude of the output of each photodetector as a function of position of the encoding pattern image. To simplify FIG. 7, the output of the B′ photodetector has been omitted.

The signals generated by these detectors are combined by detector circuits 231 and 232 to generate two logic channel signals that are 90 degrees out of phase as shown in FIG. 8. FIG. 8 illustrates the channel A and channel B signals when the encoding pattern is moving in one direction. If the encoding pattern were to move in the opposite direction, the channel B signal would lead the Channel A signal; however, the two signals would still be 90 degrees out of phase.

Circuits for converting the photodiode output signals to the channel signals shown in FIG. 6 are known in the art, and hence, will not be discussed in detail here. For the purposes of this discussion, it is sufficient to note that the channel signal corresponding to a pair of photodiode output signals such as A and A′ switches between logical one and logical zero at the points at which the output of detector A is equal to the output of detector A′.

The two channel signals provide a measurement of the direction of motion of the image of the code strip relative to the detector array. In addition, the two channel signals define 4 states that divide the distance measured by one black and one white band into quarters. The 4 states correspond to a two-bit binary number in which the first bit is determined by the value of the channel A signal and the second bit is determined by the value of the channel B signal.

It should be noted that the detector array can be viewed as an arc of a circle having the same radius and center as the circle containing the code disk band image. If the centers of these two circles are displaced from one another, or if the planes of the two circles are not aligned, the operation of the encoder is degraded significantly. The present invention provides an encoder array that is more tolerant of such alignment errors.

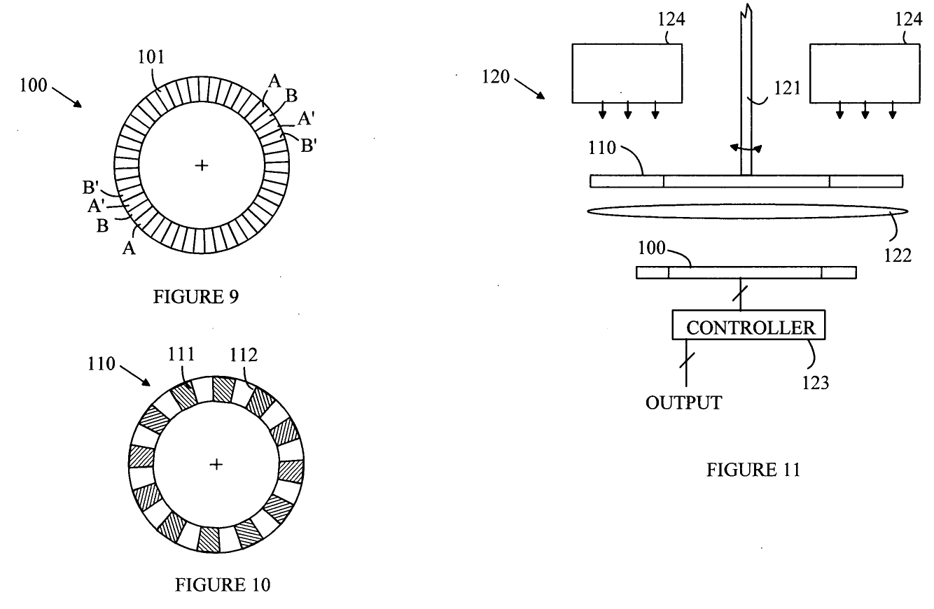

Refer now to FIGS. 9 and 10, which illustrate a photodiode array according to one embodiment of the present invention and the corresponding code wheel, respectively. Photodiode array 100 is constructed from an annular ring of photodiodes 101. Each photodiode has a truncated pie shape consisting of an area bounded by two circles having the same center and different radii and two radii of the larger circle.

Photodiode array 100 is configured to operate in the two-channel mode discussed above. The image of the entire encoding pattern is projected onto the photodiode array 100 such that each band on the encoding pattern covers two of the photodiodes on photodiode array 100. The photodiodes are divided into 4 classes in a manner analogous to that described above with reference to FIGS. 6-8. All of the photodiodes within a class are connected together. Hence, all of the A photodiodes are summed to form a sum A signal and all of the A′ photodiodes are summed to form a sum A′ signal. The sum A and sum A′ signals are then input to an A detector circuit that provides a channel A signal analogous to that described above. Similarly, the B and B′ signals are summed and input to a B detector circuit to generate a channel B signal. The channel A and channel B signals are then processed as described above. The corresponding code wheel is shown in FIG. 10. Code wheel 110 has alternating opaque and clear regions. Exemplary opaque and clear regions are shown at 111 and 112, respectively.

The combination of the code wheel and photodiode array can be used to construct a transmissive encoder. Refer now to FIG. 11, which is a cross-sectional view of a transmissive encoder 120 for measuring the position of a shaft 121. Code wheel 100 is attached to the shaft and moves therewith. Code wheel 110 is illuminated with collimated light from a light source 124. Light source 124 can be constructed from a number of LEDs and collimating lenses. It should be noted that light source 124 need only illuminate the encoding pattern on the code wheel, and hence, can include an opening for shaft 121. A lens 122 can be used to adjust the image of the code wheel such that the image matches the physical size of the photodiode array chip.

The outputs of the various photodiodes in photodiode array 101 are input to a controller 123 that sums the outputs of each class of photodiodes and combines the summed signals to provide the channel A and channel B signals discussed above. While controller 123 is shown as being separate from photodiode array 100, it is to be understood that embodiments in which photodiode array 100 and controller 123 are part of the same silicon integrated circuit substrate can also be constructed. Such single chip solutions are particularly attractive in designs that utilize CMOS photodiodes, since the control circuitry can be fabricated in the same CMOS process as the photodiodes.

Referring again to FIG. 9, the photodiodes are distributed around the ring. Ideally, the rotation axis of the image of the code wheel intersects the photodiode array at the center of the photodiode array. However, the present invention compensates for misalignment between the centers of the code disk image and photodiode array. Hence, so long as the axis intersects the photodiode array at a point proximate to the center of photodiode array, the encoder will function. It can be shown from computer simulations that this embodiment is more resistant to misalignment of the centers of the code wheel image relative to the center of the photodiode array than encoders that utilize a single sector of photodiodes. In addition, this arrangement compensates for errors due to any eccentricity of the code wheel pattern relative to the photodiode pattern.

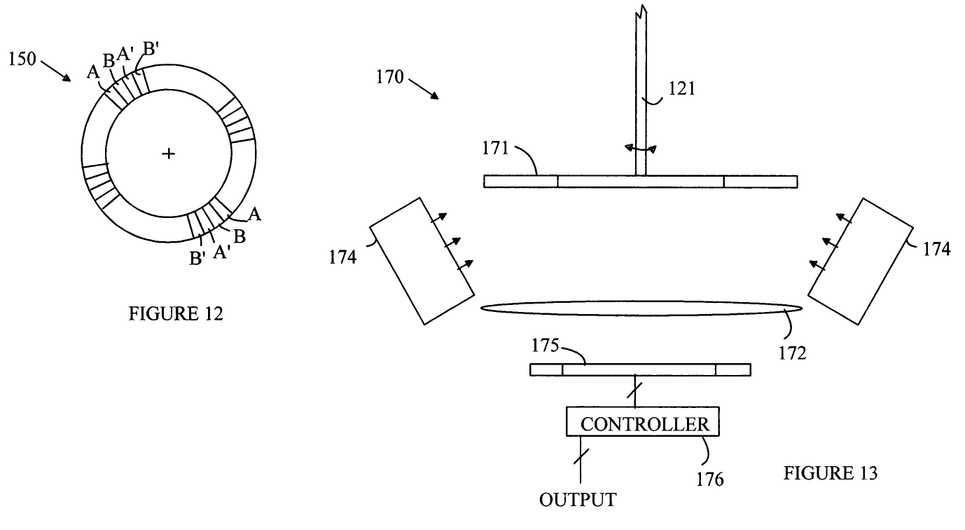

In the above-described embodiments of the present invention, the photodiode array consists of a fully populated ring of photodiodes. However, embodiments in which the ring is only partially populated can be constructed. Refer now to FIG. 12, which illustrates a photodiode array in which only a portion of the ring is actually populated with photodiodes. Photodiode array 150 includes 4 groups of photodiodes arranged such that each group is diagonally across from a corresponding group. This arrangement provides significantly better performance than the prior art single group arrangements discussed above while requiring fewer photodiodes to be operational in the chip on which the photodiode array is constructed. It should be noted that the precise positions on the ring structure at which photodiodes are to be placed can be decided after a fully populated ring structure is constructed and tested.

In addition to providing tolerance for alignment errors, the present invention also improves the signal-to-noise ratio of the signals used to provide the channel signals. By summing the outputs of a large number of photodiodes, the effective area of the photodiodes contributing to each signal is increased. Hence, an improved signal-to-noise ratio is obtained. There are many applications in which very small encoders are desired. As the size is reduced, the area of silicon available for each photodiode also decreases, and hence, the signal-to-noise ratio increases in prior art devices. The ring photodiode array of the present invention provides a mechanism for improving the signal-to-noise ratio and thereby allowing smaller encoders to be constructed.

The above-described embodiments of the present invention have been directed toward a transmissive encoder. However, reflective encoders can also be constructed utilizing a photodiode array according to the present invention. Refer now to FIG. 13, which is a cross-sectional view of a reflective encoder according to one embodiment of the present invention. Encoder 170 measures the movement of shaft 121. A reflective code wheel 171 is attached to shaft 121 and moves with the shaft. The bottom surface of code wheel 171 includes a pattern of alternating reflective and absorptive bands. A light source 174 illuminates the bottom surface. The band pattern is imaged onto a ring shaped photodiode array 175 by lens 172. Since the lens provides the imaging of the stripe pattern onto the photodiode array, light source 174 can be a diffuse source that illuminates the striped regions of the code wheel. A controller 176 performs the summing operations on the signals from the various classes of photodiode.

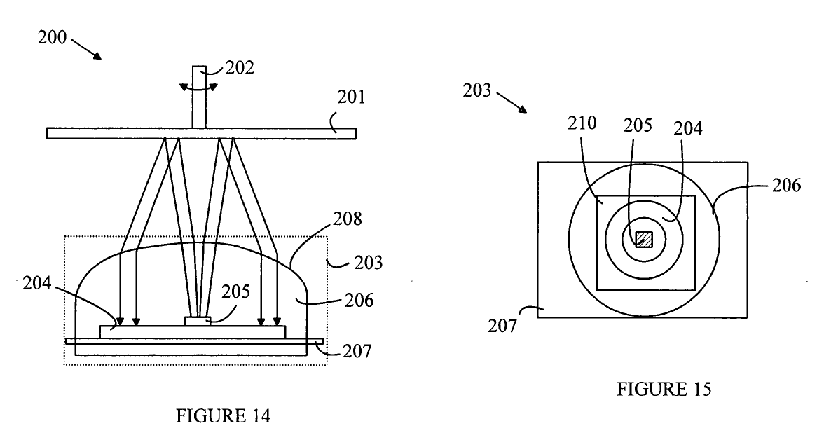

Refer now to FIGS. 14 and 15, which illustrate another embodiment of a reflective encoder according to the present invention. FIG. 14 is a cross-sectional view of encoder 200, and FIG. 15 is top view of emitter-detector module 203 shown in FIG. 14. Encoder 200 includes a code wheel 201 having the encoding pattern thereon. Code wheel 201 is attached to shaft 202 and rotates therewith. An emitter-detector module 203 illuminates code wheel 201 and detects the light reflected therefrom. Emitter-detector module 203 includes a chip 210 that contains a ring-configured detector 204. A light source 205 is mounted on this chip in a region not utilized for the detector. These components are mounted on a substrate 207 and are encapsulated in a layer 206 of clear medium such as an epoxy resin. The top surface 208 of the encapsulating medium is molded to form a lens that directs the light from light source 205 at the encoding pattern and images the returning light onto detector 204.

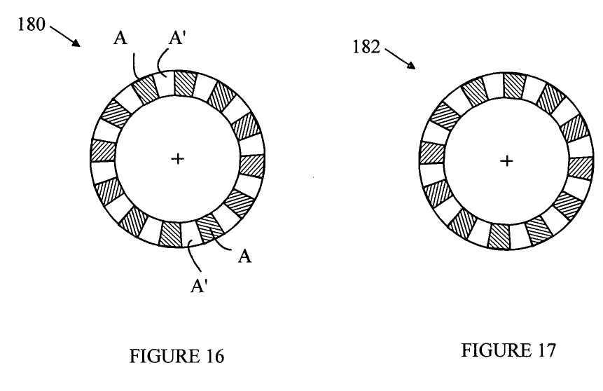

The above-described embodiments of the present invention have been directed to two channel encoders. However, the present invention can be used to implement other types of encoders. For example, in a one channel encoder, the photodiode array consists of alternating photodiodes that provide the signals A and A′. Refer now to FIGS. 16 and 17, which illustrate a photodiode array 180 and a corresponding code wheel 182 for a single channel encoder. In this case, the photodiode array areas are twice as large as those discussed above for the same number of code wheel bands, and the image of the code wheel on the photodiode array is such that the light from one white band covers the A detector when the shadow of the adjacent black bands covers the A′ detector.

Various modifications to the present invention will become apparent to those skilled in the art from the foregoing description and accompanying drawings. Accordingly, the present invention is to be limited solely by the scope of the following claims.

What is claimed is:

1. A photodiode array comprising:
a plurality of photodiodes arranged in a ring, each photodiode comprising an annular sector of said ring, each photodiode generating a signal determined by the optical radiation incident on said photodiode.

2. The photodiode array of claim 1 wherein said photodiodes are arranged in a plurality of groups around said ring, each group comprising a plurality of photodiodes in which each photodiode is assigned to a class.

3. The photodiode array of claim 1 wherein said photodiodes are arranged in a radially symmetrical pattern.

4. The photodiode array of claim 2 further comprising a plurality of sum circuits, each sum circuit generating a signal related to a sum of said signals from all of said photodiodes in one of said classes.

5. The photodiode array of claim 3 wherein said pattern comprises a region that lacks any photodiodes, said region having an area larger than that of one of said photodiodes.

6. An encoder comprising:
a photodiode array, said photodiode array comprising a plurality of photodiodes arranged in a ring, each photodiode comprising an annular sector of said ring, each photodiode generating a signal determined by the optical radiation incident on said photodiode, said photodiode array being characterized by an array center;
a code wheel comprising an annular array of alternating code bands disposed about a code wheel axis, said code wheel moving relative to said photodiode array about said code wheel axis,
a light source for illuminating said code wheel; and
an optical system for forming an image of said code wheel on said photodiode array, said image comprising alternating light and dark bands.

7. The encoder of claim 6 wherein said photodiodes are arranged in a plurality of groups around said ring, each group comprising a plurality of photodiodes in which each photodiode is assigned to a class.

8. The encoder of claim 6 wherein said photodiodes are arranged in a radially symmetrical pattern.

9. The encoder of claim 7 further comprising a plurality of sum circuits, each sum circuit generating a signal related to a sum of said signals from all of said photodiodes in one of said classes.

10. The encoder of claim 6 wherein said light source illuminates said code wheel with collimated light from one side of said code wheel and said photodiode array is located on the other side of said code wheel.

11. The encoder of claim 8 wherein said pattern comprises a region that lacks any photodiodes, said region having an area larger than that of one of said photodiodes.

12. The encoder of claim 6 wherein said ring comprises an area that lacks a photodiode between two of said photodiodes.

13. The encoder of claim 6 wherein the number of code bands is an integer multiple of the number of photodiodes in one of said groups.

14. The encoder of claim 6 wherein said light source is located on the same side of said code wheel as said photodiode array.
